(19) United States
(12) Patent Application Publication
(10) Pub. No.: US 2008/0282507 A1
(43) Pub. Date: Nov. 20, 2008

(54) Tool arm support

(75) Inventors: Mark A. Chiasson, Merrimack, NH (US); Richard E. Robicheau, Amherst, NH (US); Jennifer M. Peterson, Epping, NH (US)

Correspondence Address: HARRINGTON & SMITH, PC, 4 RESEARCH DRIVE, SHELTON, CT, 06484-6212, US

(73) Assignee: FCI Americas Technology, Inc.

(21) Appl. No.: 11/803,565

(22) Filed: May 14, 2007

(51) Int. Cl. B25F 5/02; B25G 1/10; B25G 3/38

(52) U.S. Cl. 16/440; 29/428; 72/453.01

(57) ABSTRACT

A hydraulic tool including a main unit and an arm support. The main unit includes a working head section connected to a hydraulic drive section, and a handle section adapted to allow a user to hold and operate the main unit with a single hand of an arm of the user. The arm support extends rearward from the main unit. The arm support is adapted to rest against the arm of the user proximate the user's upper forearm to partially support the hydraulic tool on the arm of the user.

### BACKGROUND OF THE INVENTION

1. Field of the Invention

The invention relates to a tool and, more particularly, to a support for supporting the tool on an arm of a user.

2. Brief Description of Prior Developments

Various different hand-held tools are known which use hydraulics, such as an electrical connector crimper or an electrical conductor cutter for example.

U.S. Pat. No. 6,745,611, which is hereby incorporated by reference in its entirety, shows one example of a tool with a handle to be held by one hand of a user. The tool is intended to be held in a single hand of a user with a “pistol grip” type of handle. U.S. Pat. No. 5,727,417, which is hereby incorporated by reference in its entirety, shows another example with a “suitcase” type of handle.

As tools are being produced with higher output force, they inevitably get heavier. The additional weight makes traditional housing designs, such as illustrated in U.S. Pat. No. 6,745,611 for example, to be somewhat uncomfortable to use for some users.

Traditionally, these larger tools are designed to be used in a “suitcase” style, similar to that illustrated in U.S. Pat. No. 5,727,417, where the operator holds a handle on top of the tool; operating activation and drain triggers with that same hand. However, there is a desire to provide a hand-held hydraulic tool, which is heavier than a conventional “pistol grip” type tool, but still have a “pistol grip” type of handle.

### SUMMARY OF THE INVENTION

In accordance with one aspect of the invention, a hydraulic tool is provided including a main unit and an arm support. The main unit includes a working head section connected to a hydraulic drive section, and a handle section adapted to allow a user to hold and operate the main unit with a single hand of an arm of the user. The arm support extends rearward from the main unit. The arm support is adapted to rest against the arm of the user proximate the user's upper forearm to partially support the hydraulic tool on the arm of the user.

In accordance with another aspect of the invention, a tool forearm support attachment for a hand-operated tool is provided comprising a first section having a front end adapted to be connected to a rear end of the hand-operated tool; and a second section connected to the first section. The second section comprises top and bottom arm contact surfaces for contacting top and bottom sides of an arm of a user while the user is holding the hand-operated tool with a hand of the arm.

In accordance with another aspect of the invention, a method of assembling a tool is provided comprising providing a hand-held, hydraulic tool comprising a frame, a hydraulic drive section located in the frame, and a working head section connected to a front end of the frame, wherein the frame comprises a handle adapted to allow a user to hold and operate the tool with a single hand of an arm of the user; and attaching a forearm support bracket to the frame, wherein the forearm support bracket extends rearward from the frame and comprises opposing surfaces for contacting the arm of the user therebetween.

### BRIEF DESCRIPTION OF THE DRAWINGS

The foregoing aspects and other features of the invention are explained in the following description, taken in connection with the accompanying drawings, wherein:

FIG. 1 is a left side elevational view of a tool comprising features of the invention;

FIG. 2 is a top plan view of the tool shown in FIG. 1;

FIG. 3 is a rear end elevational view of the tool shown in FIG. 1;

FIG. 4 is a front end elevational view of the tool shown in FIG. 1;

FIG. 5 is a bottom plan view of the tool shown in FIG. 1; and

FIG. 6 is a right side elevational view of the tool shown in FIG. 1;

FIG. 7 is a left side elevational view of the arm support shown in FIG. 1;

FIG. 8 is a right side elevational view of the arm support shown in FIG. 7;

FIG. 9 is a top plan view of the arm support shown in FIG. 7;

FIG. 10 is a bottom plan view of the arm support shown in FIG. 7;

FIG. 11 is a rear side elevational view of the arm support shown in FIG. 7;

FIG. 12 is a front side elevational view of the arm support shown in FIG. 7;

FIG. 13 is a side view illustrating another embodiment of the invention; and

FIG. 14 is a perspective view illustrating another alternate embodiment of the invention.

### DETAILED DESCRIPTION OF THE PREFERRED EMBODIMENTS

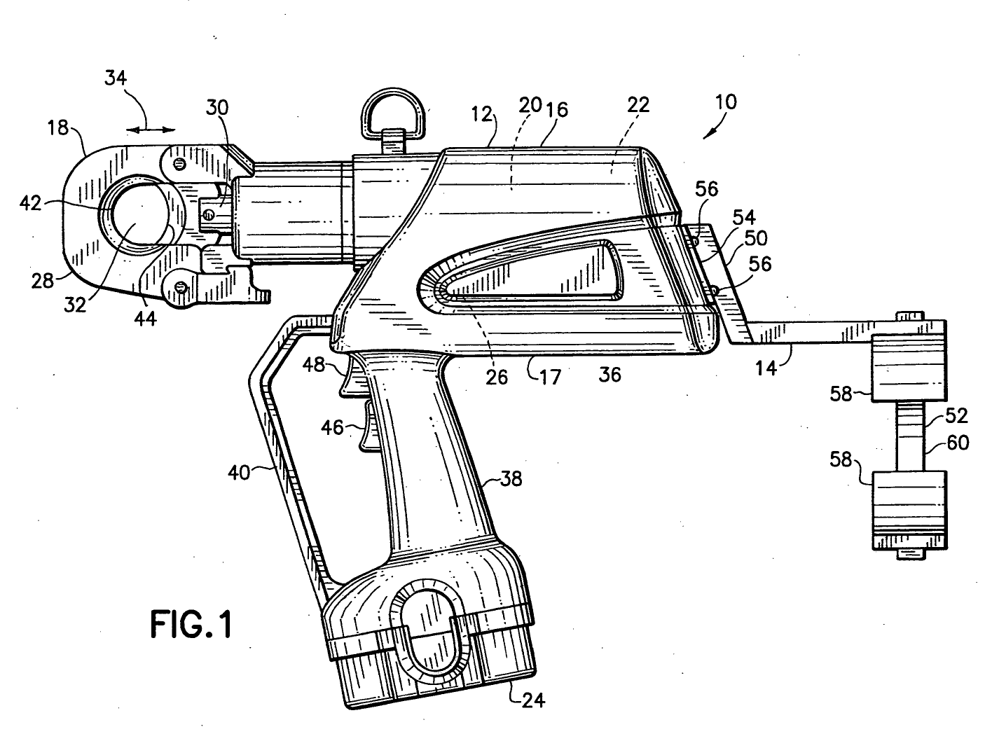

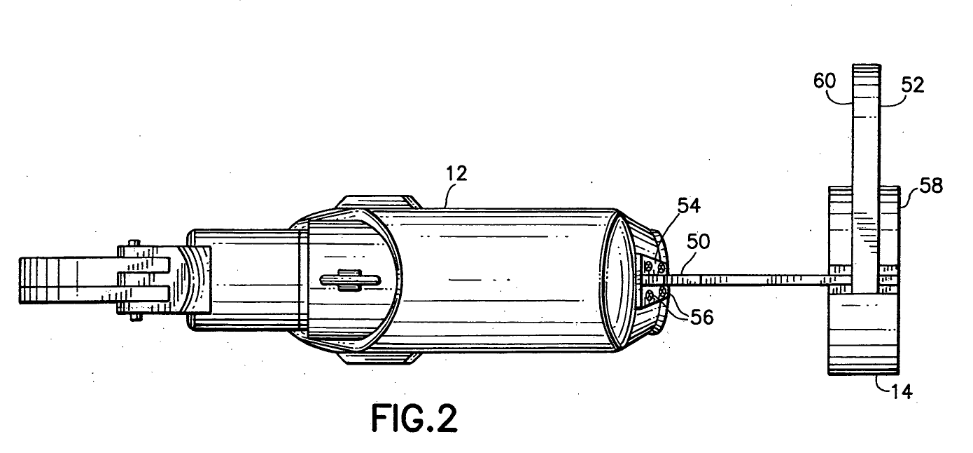

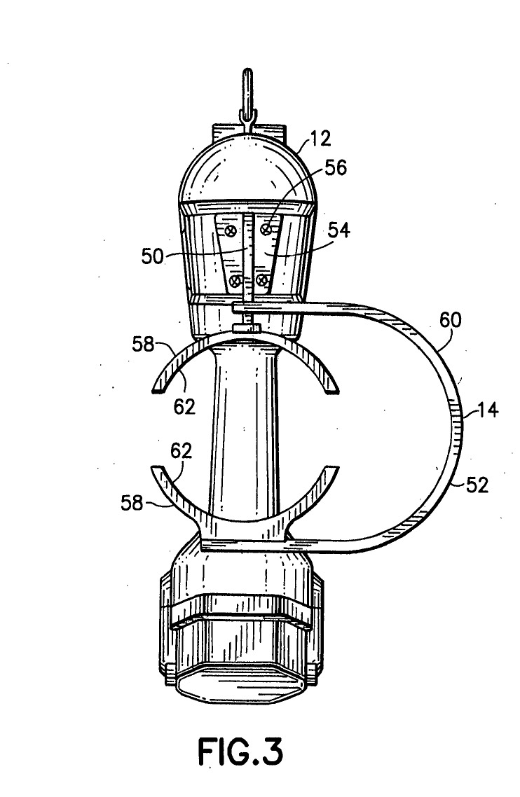

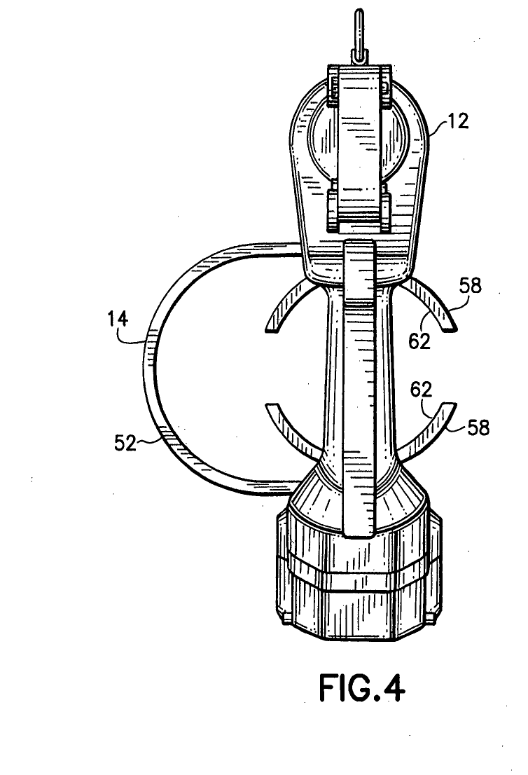

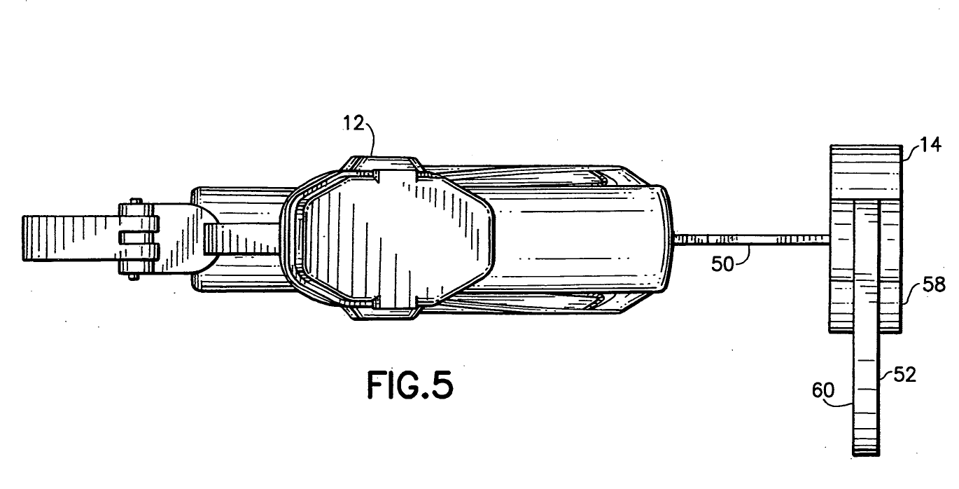

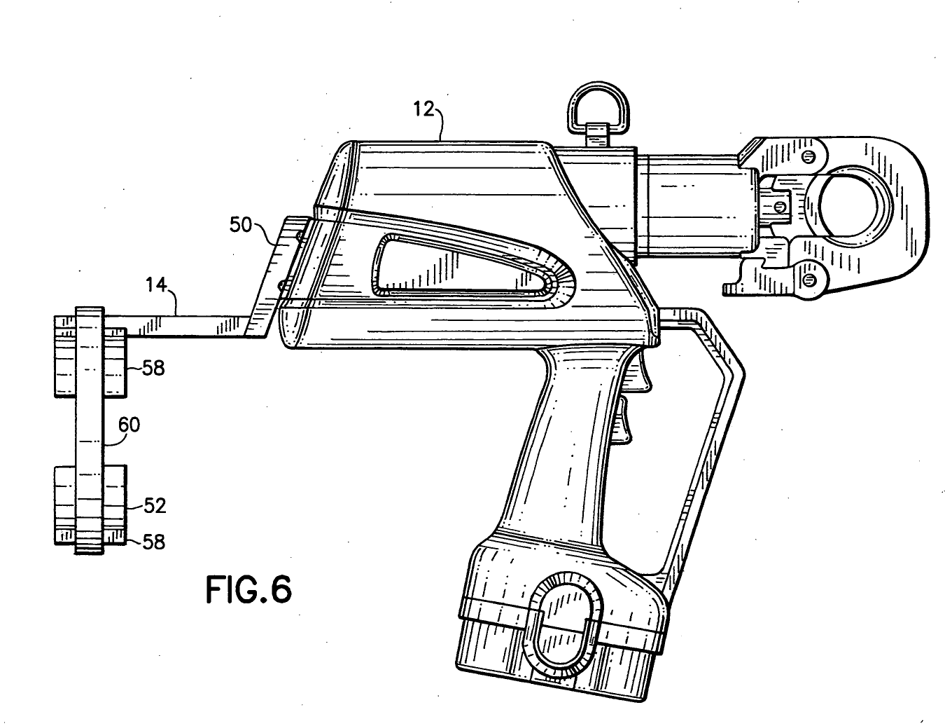

Referring to FIGS. 1-6, there are shown views of a tool 10 incorporating features of the invention.

Although the invention will be described with reference to the exemplary embodiments shown in the drawings, it should be understood that the invention can be embodied in many alternate forms of embodiments. In addition, any suitable size, shape or type of elements or materials could be used.

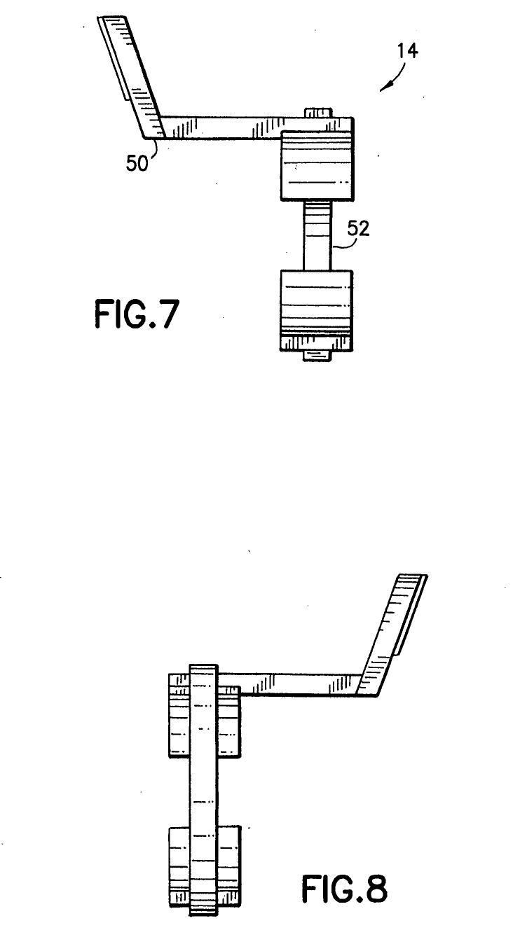

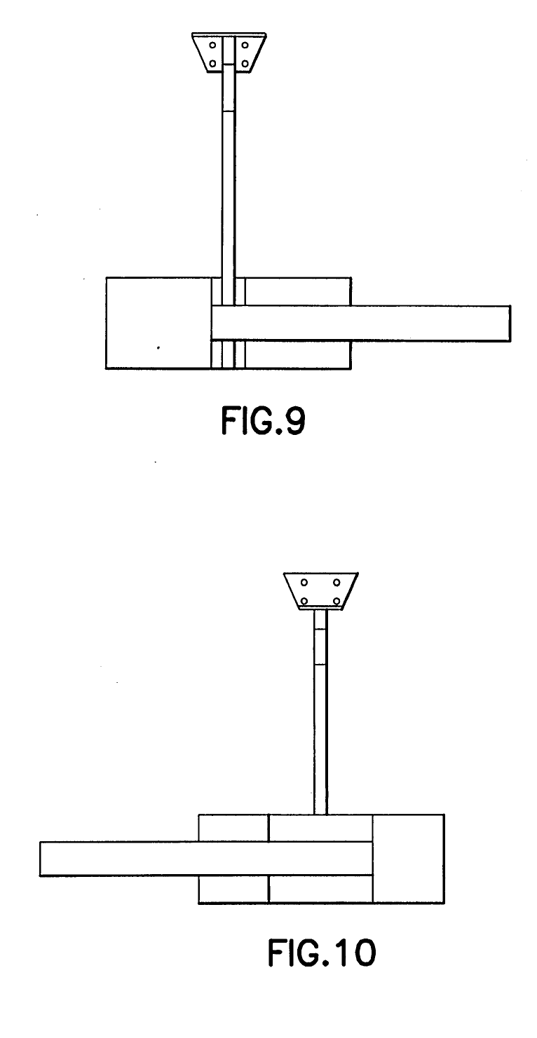

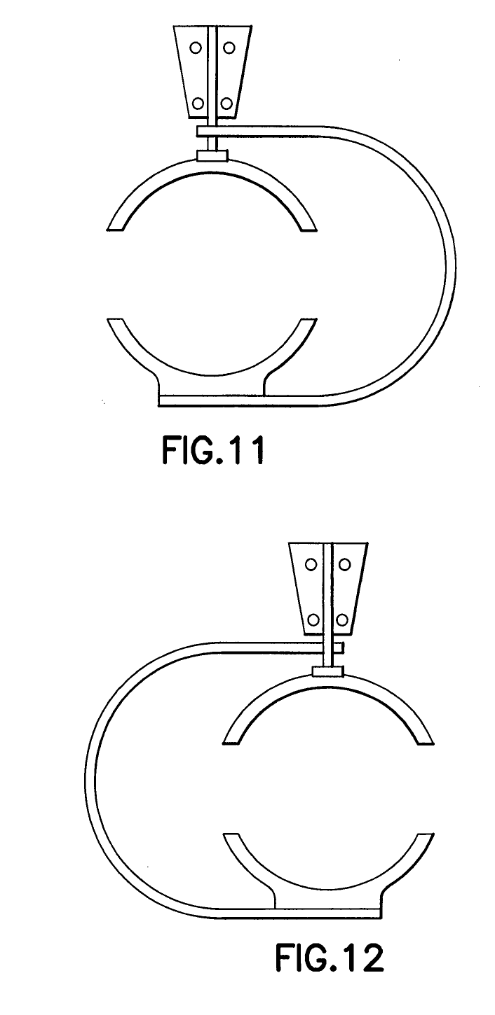

The tool 10 generally comprises a main unit 12, which is a hand-held, hydraulic tool, and an arm support or arm support bracket 14 (see also FIGS. 7-12). In the embodiment shown, the main unit 12 is a crimping tool for crimping an electrical connector onto an electrical conductor. However, features of the invention could be used in any suitable type of tool including, for example, a hydraulic cutting tool or a non-hydraulic tool. The main unit 12 generally comprises a frame 16 which can include an outer housing 17, a working head 18, a pump 20, a motor 22, a battery 24 and a fluid reservoir 26. In one type of embodiment the tool could comprise a controller (not shown), such as a printed circuit board having a microprocessor and a memory. In alternate embodiments, the tool could comprise additional or alternative components.

The frame 16 forms a ram hydraulic drive conduit system. The working head 18 comprises a frame section 28 and a ram 30. The frame section 28 is stationarily connected to the front end of the frame 12, but could be rotatable. The ram 30 is movably connected to the section 28. In the exemplary embodiment shown, the section 28 and the ram 30 are adapted to removably receive conductor crimping dies (not shown) at a connector/conductor receiving area 32.

The crimping dies (not shown) are adapted to be removably mounted to the frame section 28 and the ram 30 at opposing locations 42, 44. The two locations 42, 44 form die mounting areas of the main unit 12 for removably mounting the dies to the tool. However, features of the invention could be used in a die-less tool where the tool has permanent crimping surfaces for example. Features of the invention could also be used in a non-battery operated tool or a non-hydraulic tool. In addition, if the main unit 12 is a cutting tool, that the two locations would be cutting blade sections of the ram 30 and frame section 28.

The frame 16 forms a main section 36. The battery 24 is removably connected to the bottom front of the main section 36. However, in alternate embodiments, the frame 16 could comprise different types of shapes.

In addition, the battery 24 could be removably mounted to any suitable position on the frame. The battery 24 might also be fixedly mounted to the tool and not be removable. The battery 24 is preferably a rechargeable battery.

The motor 22 is connected to the battery 24, such as via the controller or a relay controlled by the controller. The motor 22 is adapted to operate at a nominal voltage corresponding to the voltage of the battery 24. The output shaft of the motor 22 is connected to the pump 20 by a gear reduction or gearbox. Any suitable type of gear reduction assembly could be provided.

The ram 30 is adapted to move forward and backward as indicated by arrow 34. The ram hydraulic drive conduit system is connected between the pump 20 and the rear end of the ram 30. Hydraulic fluid pumped by the pump 20 against the rear end of the ram 30 causes the ram 30 to move forward. The tool 10 preferably comprises a spring (not shown) which is adapted, as is known in the art, to return the ram 30 to its reward home position when hydraulic fluid pressure is released.

The ram 30 is located at the front of the main section 36. The pump 20, fluid reservoir 26, hydraulic fluid conduit system, and motor 22 are all located in the main section 36. In order to hold the main unit 12 and operate the tool with a single hand of a user, the frame 16 has a handle section 38. The handle section 38 has a general pistol grip shape. The handle section 38 extends downward from the bottom front of the main section 36. The battery 24 is located at the bottom end of the handle section 38. In this embodiment the frame 16 has a trigger guard 40 in front of the handle section 38. However, in alternate embodiments the trigger guard might not be provided. The main unit 12 has an actuation trigger 46 and release trigger 48 on the handle section 38. Depressing the actuation trigger 46 by the user results in activation of the motor 22 to actuate the pump 20. Depressing the release trigger 48 by the user causes hydraulic fluid to drain from behind the ram 30 back into the fluid reservoir. The ram return spring can then return the ram 30 back to a retracted position. The main unit 12 described above is merely an example of one type of main unit which the arm support 14 can be used with.

The arm support 14 generally comprises a first section 50 and a second section 52. The first section 50 is adapted to be mounted to the rear end of the frame 16. In this embodiment the first section 50 has a mounting plate 54 and is removably mounted to the frame 16 with screws 56 at the mounting plate 54. In an alternate embodiment any suitable type of removable attachment could be provided. In an alternate embodiment, the arm support might not be removably mounted to the main unit 12. In one type of alternate embodiment, the first section of the arm support could be integral with a portion of the frame 16 of the main unit 12.

The first section 50 extends in a general rearward direction from the rear end of the main unit 12 in a general cantilever fashion. The first section can be comprised of a suitable material(s), such as metal or high strength plastic for example. The second section 52 is located at the rear end of the first section 50. The second section 52 generally comprises support members 58 connected by a support frame 60. In this embodiment the second section 52 has two support members 58 comprised of resilient polymer material. However, in alternate embodiments more or less than two support members could be provided, and the support member(s) could be comprised of any suitable material(s). The support members 58 have surfaces 62 adapted to contact top and bottom sides of a user's arm. The surfaces 62 are curved to conform to the top and bottom sides of a user's forearm. More specifically, the first section 50 has a length to allow the surfaces 62 to contact the user's arm proximate the upper forearm or proximate the elbow of the user when the user is grasping the handle section 38 with the hand of that arm.

The support frame 60, in this embodiment, has a general cantilevered “C” shape. This shape extends generally laterally. The support frame 60 has a base connected to the rear end of the first section 50. The top support member 58 is located at the base of the support frame 60. The bottom support member 58 is located at the cantilevered end of the support frame 60; generally opposite to the top support member. Thus, the curved surfaces 62 are located opposing each other.

In this embodiment, the support frame 60 is adapted to deflect; similar to a leaf spring. Thus, the cantilevered end of the support frame 60 can deflect relative to the base of the support frame. This allows the two support members 58 to be movable relative to each other to adjust the spacing between the two support members 58. Thus, the second section 52 can form an adjustable clamp on the user's forearm. In an alternate embodiment, the support frame 60 might not be deflectable. In one type of embodiment, the support members 58 could be resiliently deflectable to adjust for different size user forearms. In another embodiment, the support members 58 might not be deformable.

As noted above, as tools are being produced with higher output force, they inevitably get heavier. The additional weight makes traditional “pistol grip” housing designs, such as illustrated in U.S. Pat. No. 6,745,611 for example, to be somewhat uncomfortable to use for some users. The arm support 14 allows for contact with a user's arm at the forearm as well as at the user's hand. Thus, not all of the tool's weight needs to be supported by the user's hand and wrist.

By providing the arm support 14 on a tool which has a substantially conventional design, but which is heavier because of its ability to generate higher output force, a traditional “pistol grip” housing design can be used for the main unit. This allows different users to use the main unit with or without the arm support 14; depending upon the user's preference. The main unit does not have to be totally redesigned by the manufacturer; the main unit can be designed for higher output force starting from a conventional “pistol grip” type of tool. The arm support 14 could also be sold separately from the main unit, and subsequently attached to the main unit for tools already in the market. The ornamental design of the tool 10 and the arm support 14 are also unique.

The brace of the invention is designed to spread the weight of a hand-held heavy tool between the wrist and the elbow of the user. This can reduce user fatigue normally associated with tools of this nature; especially at the hand and wrist. The design can work as an optional accessory to existing lines of pistol-grip style tools. The housings could be modified with a receptacle designed to accept the brace. The user could install and remove the brace according to his or her preference, or the brace could be permanently mounted.

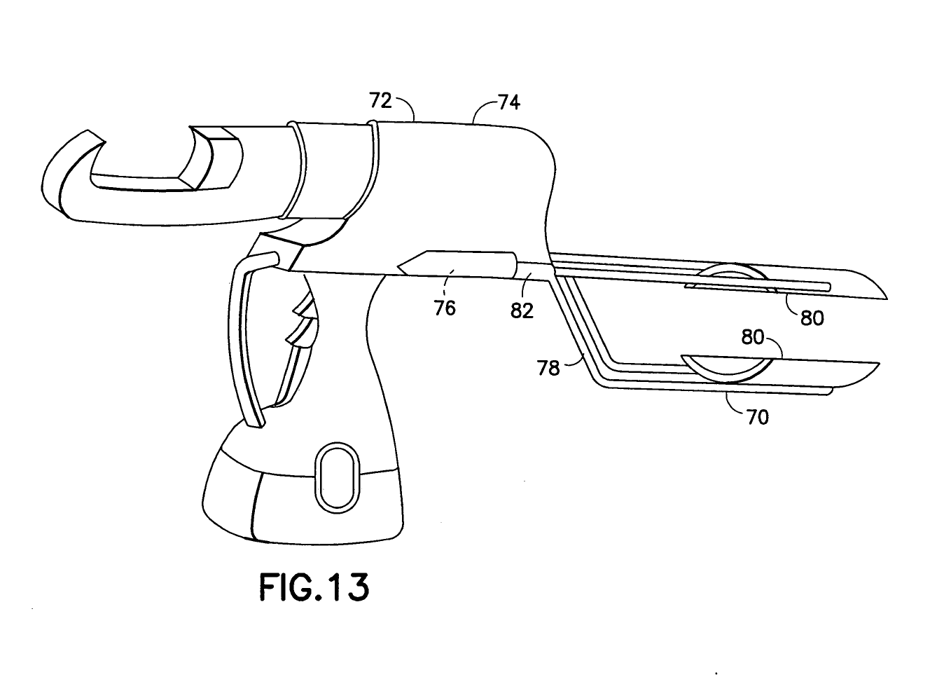

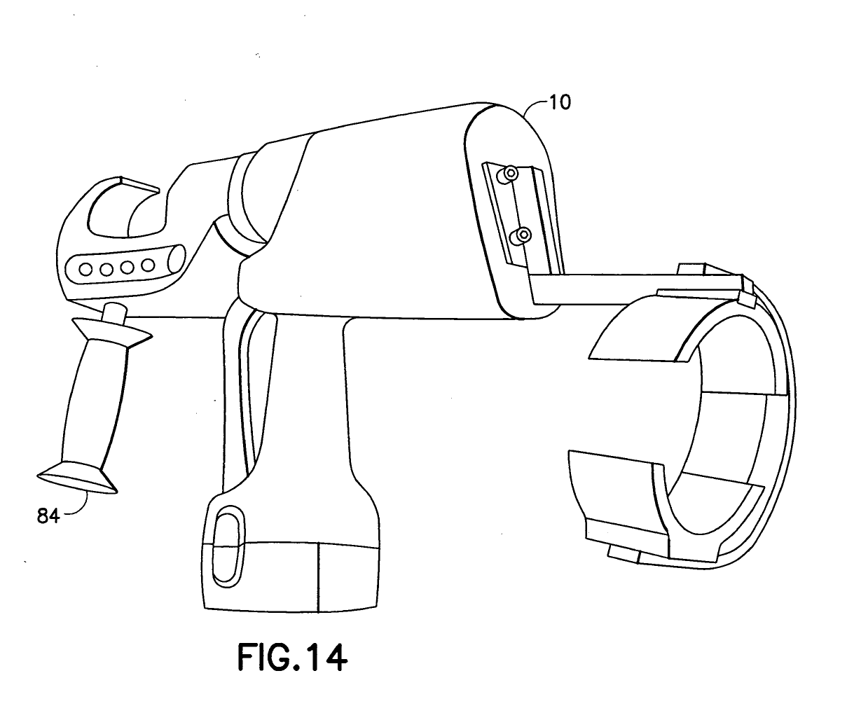

FIG. 13 shows an alternative embodiment where the brace or arm support 70 is removably attached to the main unit 72. The main unit 72 is substantially identical to the main unit 12 shown in FIG. 1 except that the housing 74 of the main unit 72 has mounting slots 76 on opposite sides of the rear of the main unit. The brace 70 has a frame 78 and two saddles 80. The saddles 80 are adapted to receive the user's forearm therebetween. The frame 78 has front mounting posts 82 which are slid into the mounting slots 76 to mount the brace 70 to the main unit 72. FIG. 14 shows another alternate embodiment. This embodiment is identical to the embodiment shown in FIG. 1, but includes a front handle 84 for the other hand of the user. The front handle 84 could be removable.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A hydraulic tool comprising:
a main unit comprising a working head section connected to a hydraulic drive section, and a handle section adapted to allow a user to hold and operate the main unit with a single hand of an arm of the user; and
an arm support extending rearward from the main unit, wherein the arm support is adapted to rest against the arm of the user proximate the user's upper forearm to partially support the hydraulic tool on the arm of the user.

2. A hydraulic tool as in claim 1 wherein the tool is an electrical connector crimping tool.

3. A hydraulic tool as in claim 1 wherein the tool is an electrical conductor cutting tool.

4. A hydraulic tool as in claim 1 wherein the arm support is removably connected to the main unit.

5. A hydraulic tool as in claim 1 wherein the arm support comprises two opposing arm contact surfaces to contact the arm therebetween.

6. A hydraulic tool as in claim 5 wherein the arm support comprises two opposing deformable support members forming the contact surfaces, respectively.

7. A hydraulic tool as in claim 6 wherein the opposing deformable support members are comprised of a resilient polymer material.

8. A hydraulic tool as in claim 5 wherein the arm support comprises a cantilevered section, wherein a first one of the opposing arm contact surfaces is located proximate a base of the cantilevered section, and wherein a second one of the opposing arm contact surfaces is located proximate a cantilevered end of the cantilevered section.

9. A hydraulic tool as in claim 5 wherein the two opposing arm contact surfaces are movable relative to each other.

10. A hydraulic tool as in claim 9 wherein the arm support is adapted to adjustably clamp the arm of the user between the two opposing arm contact surfaces.

11. A tool forearm support attachment for a hand-operated tool comprising:
a first section having a front end adapted to be connected to a rear end of the hand-operated tool; and
a second section connected to the first section, wherein the second section comprises top and bottom arm contact surfaces for contacting top and bottom sides of an arm of a user while the user is holding the hand-operated tool with a hand of the arm.

12. A tool forearm support attachment as in claim 11 wherein the front end of the first section is adapted to be removably connected to the rear end of the hand-operated tool.

13. A tool forearm support attachment as in claim 11 wherein the second section comprises two opposing deformable support members forming the top and bottom contact surfaces, respectively.

14. A tool forearm support attachment as in claim 13 wherein the opposing deformable support members are comprised of a resilient polymer material.

15. A tool forearm support attachment as in claim 11 wherein the second section comprises a cantilevered section, wherein the top arm contact surface is located proximate a base of the cantilevered section, and wherein the bottom arm contact surface is located proximate a cantilevered end of the cantilevered section.

16. A tool forearm support attachment as in claim 11 wherein the arm contact surfaces are movable relative to each other.

17. A tool forearm support attachment as in claim 11 wherein the arm support is adapted to adjustably clamp the arm of the user between the arm contact surfaces.

18. A hydraulic tool comprising:
a main unit of a hand-operated tool comprising a working head section connected to a hydraulic drive section, and a handle section adapted to allow a user to hold and operate the main unit with a single hand of an arm of the user; and
a tool forearm support attachment as in claim 11 attached to the main unit and extending rearward from the main unit.

19. A method of assembling a tool comprising:
providing a hand-held, hydraulic tool comprising a frame, a hydraulic drive section located in the frame, and a working head section connected to a front end of the frame, wherein the frame comprises a handle adapted to allow a user to hold and operate the tool with a single hand of an arm of the user; and
attaching a forearm support bracket to the frame, wherein the forearm support bracket extends rearward from the frame and comprises opposing surfaces for contacting the arm of the user therebetween.

20. A method as in claim 19 wherein attaching a forearm support bracket to the frame comprises removably attaching the forearm support bracket to the frame.
